(19) United States
(12) Patent Application Publication
(10) Pub. No.: US 2009/0133521 A1
(43) Pub. Date: May 28, 2009

(54) Two-axle drive system

(76) Inventors: Jens Kunert, Tuebingen (DE); Wolfgang Schnurr, Nehren (DE); Georg Boeing, Rottenburg (DE)

Correspondence Address: Striker, Striker & Stenby, 103 East Neck Road, Huntington, NY, 11743, US

(21) Appl. No.: 12/275,410

(22) Filed: Nov. 21, 2008

(30) Foreign Application Priority Data
Nov. 22, 2007 (EP) 07022664.2

(51) Int. Cl. F16H 37/16

(52) U.S. Cl. 74/22 R

(57) ABSTRACT

In a two-axle drive system for holding and moving large sunlight-absorbing, concentrating or reflecting surfaces about an azimuth axis and an elevation axis, a first gear unit which is driven by a first drive is provided for a rotational movement about the azimuth axis, and a second gear unit which is driven by a second drive is provided for a rotational movement about the elevation axis, at least one gear unit includes a spur gear stage with conical spur gear toothing, and the associated shaft is displaceable along its longitudinal axis. High accuracy is obtained as a result.

### CROSS-REFERENCE TO RELATED APPLICATION

The invention described and claimed hereinbelow is also described in European Patent Application EP07022664.2 filed on Nov. 22, 2007. This European Patent Application, whose subject matter is incorporated here by reference, provides the basis for a claim of priority of invention under 35 U.S.C. 119(a)-(d).

### BACKGROUND OF THE INVENTION

The present invention relates to a two-axle drive system for holding and moving sunlight-absorbing, concentrating or reflecting surfaces about an azimuth axis and an elevation axis, in the case of which a first gear unit which is driven by a first drive is provided for a rotational movement about the azimuth axis, and a second gear unit which is driven by a second drive is provided for a rotational movement about the elevation axis.

Solar power plants operate according to different principles. Examples include parabolic trough power plants, tower power plants, and photovoltaic power plants. In all of these power plants, it is necessary to move large surfaces, e.g., large mirror surfaces, photovoltaic modules, Fresnel modules, etc. These surfaces must track the position of the sun with high accuracy, since even the slightest deviations in position result in poorer efficiency. In particular, it is necessary for the drives provided therefor to operate with an accuracy of <1 mrad. Due to the large surfaces, e.g., in the range of 20 m² to 40 m², the drives must also have great stability and stiffness against wind forces, since wind forces may result in very slight deviations in position.

### SUMMARY OF THE INVENTION

The object of the present invention is to provide a two-axle drive system that fulfills the requirements mentioned above, and using which it is possible to set the accuracy in particular.

This object is attained in a surprising and simple manner using a two-axle drive system of the type described initially, in the case of which at least one of the gear units includes a spur gear stage with conical spur gear toothing, and the associated shaft being displaceable along its longitudinal axis. This enables the tooth flank play to be set, thereby increasing precision and reducing the play in the gear unit. The surfaces to be oriented may be positioned in a highly accurate manner. Both gear units preferably include a spur gear stage as the end stage with conical spur gear toothing, and shafts assigned to both of them are displaceable along their longitudinal axis. In particular, the two gear units preferably have the same design.

In a particularly preferred embodiment, it may be provided that the shaft is supported by at least one and preferably at least two bearing system(s) which is/are displaceable at least partially (axially) relative to the shaft. Given that the bearing systems are adjustable axially relative to the shaft, the axial position of the shaft may be changed, thereby making it possible to reduce the tooth flank play of the spur gear unit. The bearing systems preferably remain in the same position in the housing of the two-axle drive system. This means that the bearing systems are displaceable axially on the shaft.

According to an embodiment of the present invention, it may be provided that the at least one bearing system is designed using sliding bearings or roller bearings, in particular axial angular needle bearings, tapered roller bearings, or a combination of a radial needle bearing and an axial needle bearing. Particular advantages result when axial angular needle bearings are used, in the case of which cylindrical rollers are located at an angle in a cage. These rollers bear against running disks in a linear manner. As a result, it is possible to realize a bearing without play and with high stiffness. In particular, the bearing may be set with a preload, without play.

It is particularly advantageous in this context when the bearing system includes two running disks composed of steel, in particular spring steel, between which the bearing is located. Via this measure, the rollers roll on the running disk. The load therefore acts on the running disks and not on the housing. The housing may therefore be composed of a softer material, e.g., aluminum.

A particularly simple, exact, and reliable displacement of the bearing system results when the bearing system includes a set collar, the shaft including an outer thread and the set collar including an inner thread, and the set collar being screwed onto the thread of the shaft. The set collar may therefore be adjusted easily by rotating it relative to the shaft in the axial direction of the shaft.

In an alternative embodiment, it may be provided that the shaft includes a circumferential groove in which a support ring is located, against which a bearing part of the bearing system bears via one or more shims (support disks). By using support disks having different thicknesses or by using different numbers of support disks, the bearing may be displaced relative to the shaft, or the shaft may be displaced relative to the bearing while the position of the bearing remains the same.

According to an embodiment of the present invention, a housing may be provided, and one or more bearing seats may be formed in the housing. The bearing seats may be considered to be a component of the bearing systems. The bearing seats in the housing define a position of the bearing in the housing. Running disks are preferably provided between the bearings and the bearing seats. It is also basically feasible to design the housing as a single piece. Preferably, however, one housing part is assigned to each gear unit, and the housing parts are connected to one another, in particular via a threaded connection. As a result, mass production of the two-axle drive system may be realized in a particularly simple manner.

In a preferred embodiment, it may be provided that the entire housing is situated in a rotatable manner. A rigid system is made possible as a result. Both of the gear units or parts of the two gear units are moved together about the azimuth axis.

A preferred embodiment of the present invention is characterized by the fact that at least one shaft includes conical toothing in a region of its circumference, or a wheel with conical spur gear toothing is non-rotatably situated on the shaft. Depending on which gear ratio is required and what the diameter of the shaft is, the spur gear toothing is formed directly on the shaft, or a wheel with a diameter larger than that of the shaft diameter is used, the spur gear toothing being formed on the wheel.

Advantageously, the at least one gear unit and preferably each gear unit includes a worm gear stage, preferably with a high gear ratio, the output shaft including conical spur gear toothing. A particularly high accuracy, i.e., an exact orientation of the surfaces, may be attained as a result.

In a particularly preferred embodiment of the present invention, it may be provided that the at least one gear unit, and preferably each gear unit, includes a first and second worm gear stage, thereby resulting in self-locking. Due to the self-locking, a specified position may be retained exactly. The position may be retained without the need for additional braking. Both of the gear stages are preferably integrated in the housing. This lowers the costs of assembly and manufacture.

When drive interfaces are provided in order to position the drives, it is possible to easily install standard drives, in particular standard gear unit motors with a defined interface, on the housing, in particular via a flange-mounting. It is therefore possible to connect drives having different dimensions to the housing as necessary.

Further features and advantages of the present invention result from the detailed description of embodiments of the invention presented below with reference to the figures in the drawing, which shows the details that are essential to the present invention. Further features and advantages of the present invention also result from the claims. The individual features can be realized individually, or they can be combined in any possible manner in different variations of the present invention.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 shows a perspective view of the housing of the two-axle drive system;

FIG. 2 shows a detailed view of conical spur gear toothing;

FIG. 3 shows a top view of shaft and a spur gear stage;

FIG. 4 shows a sectional view through a part of a gear unit and a shaft;

FIG. 5 shows an enlarged, detailed view of FIG. 4 in the region of the bearing system;

FIG. 6 shows an alternative embodiment for an axial bearing displacement; and

FIG. 7 shows a block diagram of drive trains realized on a two-axle drive system.

### DESCRIPTION OF THE PREFERRED EMBODIMENTS

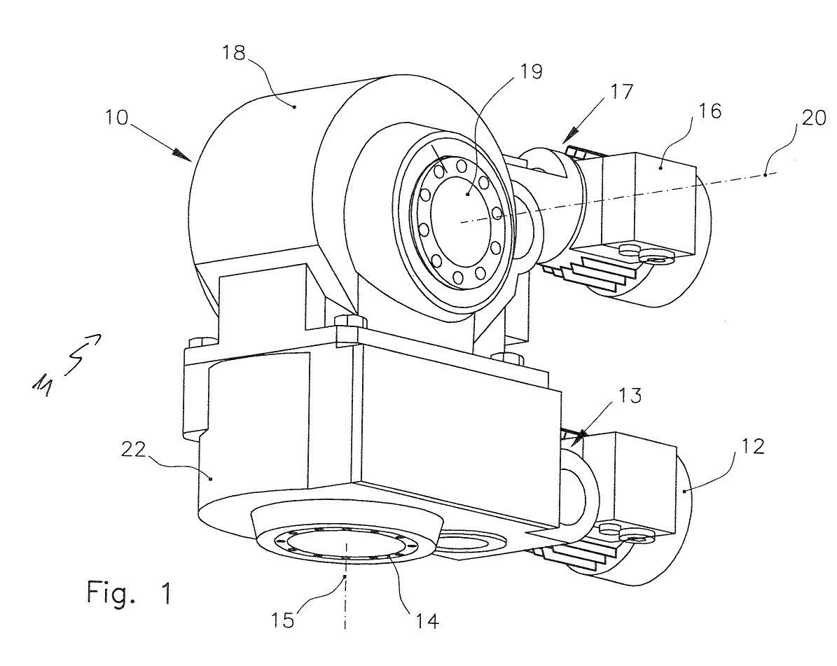

Housing 10 of two-axle drive system 11 is shown in FIG. 1. Drive 12, which is flange-mounted on a drive interface 13, drives a worm shaft of a first worm gear stage. In turn, this worm gear stage drives the worm shaft of a second worm gear stage, which, in turn, drives a shaft 14 via a spur gear stage. Since shaft 14 is non-rotatably situated, housing 10 may therefore be rotated about azimuth axis 15.

Drive 16 is also connected to a drive interface 17. It also drives two worm gear stages and a spur gear stage. Shaft 19 located in upper housing part 18 is driven as a result. Via drive 16, it is therefore possible to realize a rotational movement about elevation axis 20. Upper housing part 18 and lower housing part 22 are connected to each other via a threaded connection.

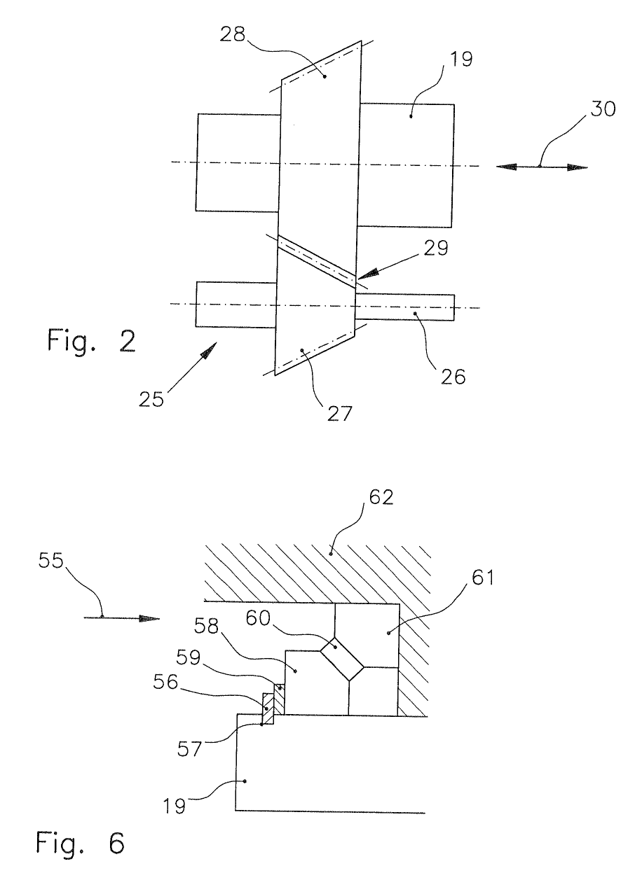

FIG. 2 shows a conical spur gear unit 25. Output shaft 26 of a worm gear stage and shaft 19 include conical spur gear toothing 27, 28. Tooth flank play 29 may be changed by moving shaft 19 in the direction of double arrow 30. Tooth flank play 29 is increased or reduced, depending on the direction in which shaft 19 is displaced.

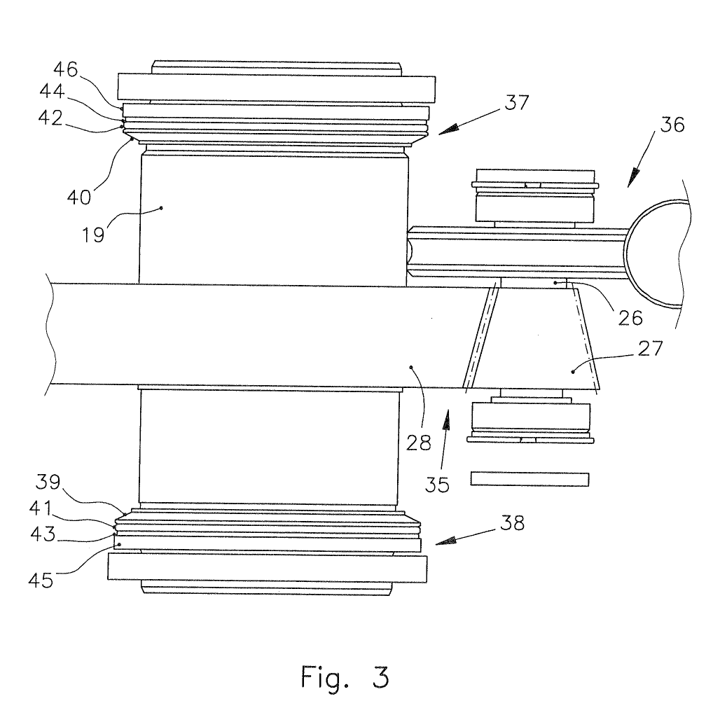

FIG. 3 shows a top view of a spur gear unit 35 and an upstream worm gear stage 36. The spur gear stage includes spur gear toothing 28 on shaft 19 and spur gear toothing 27 on shaft 26. Shaft 19 includes bearing systems 37, 38 on both ends, bearing systems 37, 38 being displaceable in the axial direction of shaft 19. Since bearing systems 37, 38 are fixed in position in a housing, a displacement of bearing systems 37, 38 in the axial direction of shaft 19 causes shaft 19 to be displaced in the axial direction, thereby enabling tooth flank play 29 to be set. Each bearing system 37, 38 includes a running disk 39, 40, a bearing 41, 42, further running disks 43, 44, and a set collar 45, 46. Set collars 45, 46 are guided on a thread of shaft 19 and are displacable in the axial direction of shaft 19 via a rotational motion. Bearings 41, 42 are located between running disks 39, 43 and 40, 44.

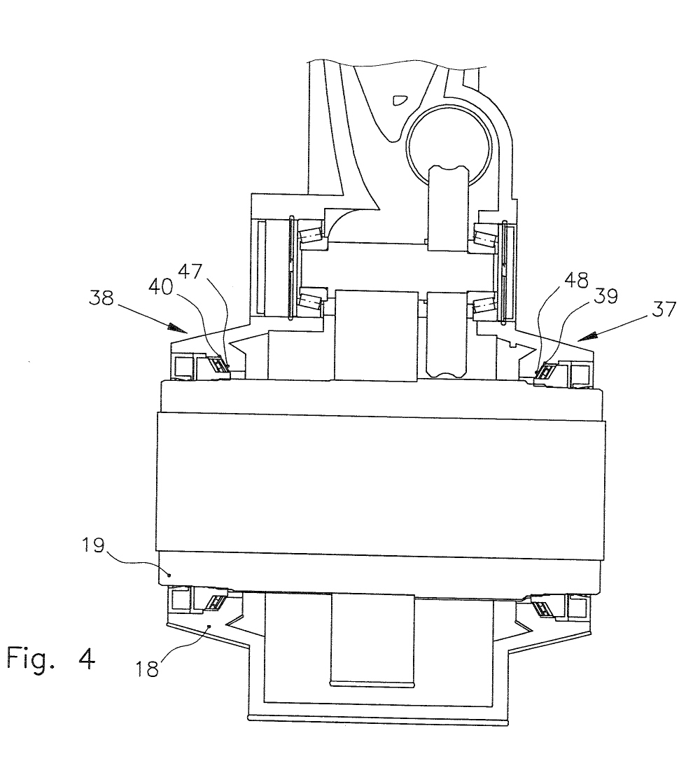

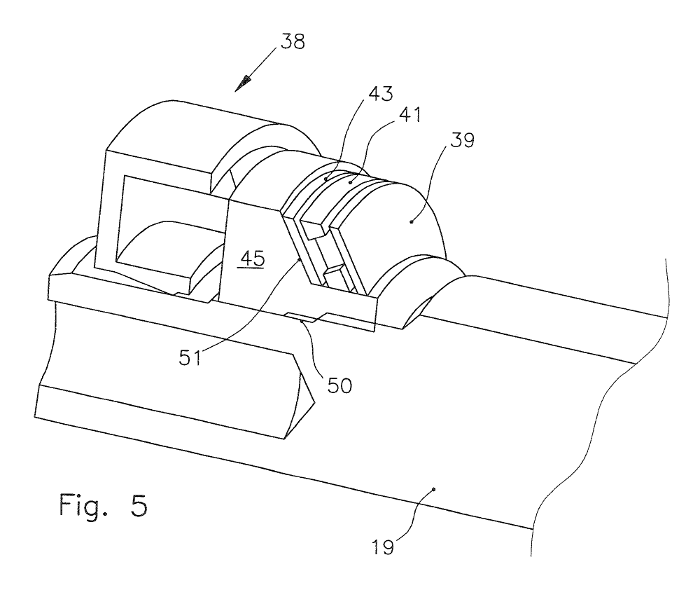

FIG. 4 shows a cross-sectional view through shaft 19 and upper housing part 18. It is shown that bearing systems 37, 38 bear against housing 18. In particular, running disks 39, 40 bear against corresponding bearing seats 47, 48 of housing 18. Bearing system 38 is shown in an enlarged view in FIG. 5. It is shown clearly that set collar 45 is guided on a thread 50 of shaft 19. Set collar 45 includes a slanted flank 51, against which running disk 43 bears. Bearing 41 is located between running disks 43, 39. Running disk 39, which is also positioned at a slant, bears against the housing, which is not depicted here. By displacing set collar 45, it is possible to displace bearing system 38 in the axial direction of shaft 19. Bearing 41 may also be clamped between running disks 39, 43. Bearing 41 is an axial angular needle bearing.

FIG. 6 shows an alternative embodiment of bearing system 55. This bearing system includes a support ring 56, which is situated in a circumferential groove 57 of shaft 19. A shim 59 is located between running disk 58 and support disk 56. Bearing 60 bears against housing 62 via running disk 61. Shaft 19 is displaced axially by using shims 59 of different thicknesses or by using a different number of shims 59.

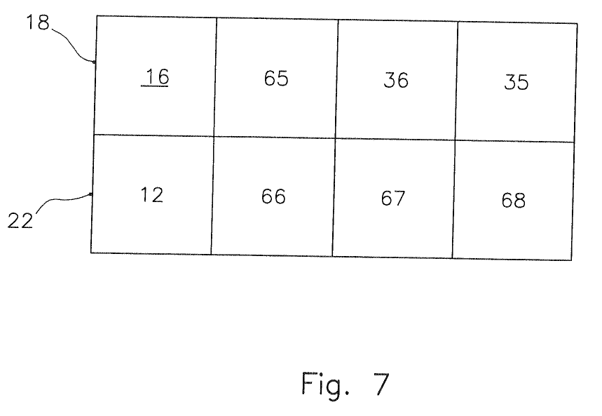

FIG. 7 is a schematic illustration of the design of the two-axle drive system according to the present invention. Drive 16 is provided in or on upper housing part 18, drive 16 driving a first worm gear stage 65. This drives second worm gear stage 36 which interacts with spur gear stage 35 to drive shaft 19. In an analogous manner, drive 12 is located in or on lower housing part 22, drive 12 interacting with a first worm gear stage 66 which, in turn, drives a second worm gear stage 67. Second worm gear stage 67 interacts with a spur gear stage 68 to drive shaft 14. Gear stages 65, 36, and 35 form a first gear unit, and gear stages 66, 67, and 68 form a second gear unit.

It will be understood that each of the elements described above, or two or more together, may also find a useful application in other types of constructions differing from the types described above.

While the invention has been illustrated and described as embodied in a two-axle drive system, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A two-axle drive system for holding and moving sunlight-absorbing, concentrating or reflecting surfaces about an azimuth axis and an elevation axis, comprising a first gear unit; a first drive driving said first gear unit for a rotational movement about the azimuth axis; a second gear unit; a second drive driving said second gear unit for a rotational movement about the elevation axis, at least one of said gear units including a spur gear stage with conical spur gear toothing, and an associated shaft displaceable along its longitudinal axis.

2. A two-axle drive system as defined in claim 1, further comprising at least one bearing system supporting said shaft and displaceable at least partially axially relative to said shaft.

3. A two-axle drive system as defined in claim 1, further comprising at least two bearing systems supporting said shaft and displaceable at least partially axially relative to said shaft.

4. A two-axle drive system as defined in claim 2, wherein said at least one bearing system is configured using bearings selected from the group consisting of sliding bearings and roller bearings.

5. A two-axle drive system as defined in claim 4, wherein said at least one bearing system is configured using the sliding bearings or roller bearings selected from the group consisting of axial angular needle bearings, tapered roller bearings, and a combination of radial needle bearing and an axial needle bearing.

6. A two-axle drive system as defined in claim 2, wherein said at least one bearing system includes two running disks composed of steel and a bearing located there between.

7. A two-axle drive system as defined in claim 2, wherein said at least one bearing system includes a set collar having an inner thread and said shaft having outer thread, said set collar being screwed on said outer thread of said shaft.

8. A two-axle drive system as defined in claim 1, wherein said shaft includes a circumferential groove in which a support ring is located, against which a bearing part of the bearing system bears via at least one shim.

9. A two-axle drive system as defined in claim 1, further comprising a housing provided with at least one bearing seat.

10. A two-axle drive system as defined in claim 1, wherein said shaft includes a conical toothing in a region of its circumference

11. A two-axle drive system as defined in claim 1, further comprising a wheel with a conical spur gear toothing which is non-rotatably arranged on said shaft.

12. A two-axle drive system as defined in claim 1, wherein at least one of said gear units has a worm gear stage, further comprising an output shaft provided with a conical spur gear toothing.

13. A two-axle drive system as defined in claim 1, wherein at least one of said gear units has a first and a second worm gear stage providing self-locking.

14. A two-axle drive system as defined in claim 1, further comprising drive interfaces for positioning said drives.
